(19) United States
(12) Patent Application Publication
(10) Pub. No.: US 2010/0041813 A1
(43) Pub. Date: Feb. 18, 2010

(54) BOEHMITE-FILLED POLYPROPYLENE RESIN COMPOSITION AND MOLDED ARTICLE COMPRISING THE SAME

(75) Inventors: Katsuhisa Kitano, Rabigh (SA); Kenji Ikeda, Chiba (JP); Yusuke Kawamura, Ehime (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/532,266

(22) PCT Filed: Mar. 24, 2009
(86) PCT No.: PCT/JP2008/056256

§ 371 Date: Sep. 21, 2009

(30) Foreign Application Priority Data
Mar. 23, 2007 (JP) 2007-076407

(51) Int. Cl. C08K 3/22

(52) U.S. Cl. 524/430

(57) ABSTRACT

There is provided a polypropylene resin composition comprising 50 to 99% by weight of a polypropylene resin (A), which contains a propylene homopolymer and/or a propylene-ethylene random copolymer containing 1.0% by weight or less of ethylene units, and 1 to 50% by weight of boehmite (B) having a BET specific surface area of 20 to 80 m²/g, c-axis length of 30 to 300 nm, and a ratio of a-axis length to b-axis length (a-axis length/b-axis length) of 5 or more, provided that the total of the polypropylene resin (A) and boehmite (B) is 100% by weight.

### TECHNICAL FIELD

The present invention relates to a boehmite-filled polypropylene resin composition and a molded article comprising the resin composition. In more detail, the present invention relates to a boehmite-filled polypropylene resin composition useful as a material for a molded article, which is excellent in its rigidity, heat resistance and dimension stability.

### BACKGROUND ART

As a polypropylene resin material excellent in its rigidity, heat resistance and dimension stability, there is known heretofore a polypropylene resin composition containing an inorganic filler.

For example, JP 2003-286372A discloses that a molded article excellent in its rigidity and surface hardness can be obtained from a polypropylene resin composition, which composition is obtained by blending aluminum hydroxide having a maximum diameter of 20 μm or smaller. Also, JP 2005-126287A discloses that a molded article excellent in its surface hardness can be obtained from a polypropylene resin composition, which composition contains boehmite having an average major axis of 100 to 900 nm.

The above polypropylene resin compositions have been required to be further improved in their rigidity and dimension stability.

### DISCLOSURE OF INVENTION

An object of the present invention is to provide a polypropylene resin composition useful as a material for a molded article, which is excellent in its rigidity and dimension stability.

The present invention is a polypropylene resin composition comprising:
50 to 99% by weight of a polypropylene resin (A), which contains a propylene homopolymer and/or a propylene-ethylene random copolymer containing 1.0% by weight or less of ethylene units; and
1 to 50% by weight of boehmite (B) having a BET specific surface area of 20 to 80 m²/g, c-length of 30 to 300 nm, and a ratio of a-axis length to b-axis length (a-axis length/b-axis length) of 5 or more;
   provided that the total of the polypropylene resin (A) and boehmite (B) is 100% by weight.

### BRIEF DESCRIPTION OF THE DRAWINGS

FIG. 1 shows a-axis, b-axis and c-axis of boehmite particles.

### BEST MODE FOR CARRYING OUT THE INVENTION

The polypropylene resin (A) used in the present invention contains a propylene homopolymer and/or a propylene-ethylene random copolymer containing 1.0% by weight or less of ethylene units, which content can be measured according to an IR method or an NMR method disclosed in “New Edition: KOBUNSHI ANALYSIS HANDBOOK” edited by The Chemical Society of Japan, Society of Polymer Analysis and Research, published by Kinokuniya Co., Ltd. (1995).

From a viewpoint of rigidity and heat resistance, the polypropylene resin (A) is preferably a propylene homopolymer, or a propylene-ethylene random copolymer containing 0.5% by weight or less of ethylene units, or a mixture of a propylene homopolymer with a propylene-ethylene random copolymer containing 0.5% by weight or less of ethylene units; more preferably a propylene homopolymer, or a propylene-ethylene random copolymer containing 0.3% by weight or less of ethylene units, or a mixture of a propylene homopolymer with a propylene-ethylene random copolymer containing 0.3% by weight or less of ethylene units; and most preferably a propylene homopolymer.

The polypropylene resin (A) is produced according to a method such as a solution polymerization method, a slurry polymerization method, a bulk polymerization method and a gas phase polymerization method. Those polymerization methods are used alone or in a combination of two or more thereof. Examples of a production method of the polypropylene resin (A) are polymerization methods disclosed in documents such as “Shin Polymer Seizo Process” (edited by Yasuji SAEKI, published by Kogyo Chosakai Publishing, Inc. (1994)), JP 4-323207A and JP 61-287917A.

Examples of a catalyst used for producing the polypropylene resin (A) are a multiple site catalyst and a single site catalyst. The multiple site catalyst is preferably a catalyst obtained using a solid catalyst component containing a titanium atom, a magnesium atom and a halogen atom. The single site catalyst is preferably a metallocene catalyst.

Boehmite (B) is a powder having a BET specific surface area of 20 to 80 m²/g, c-axis length of 30 to 300 nm, and a ratio (a-axis length to b-axis length) of 5 or more, and is represented by the chemical formula of AlOOH. A crystal structure of boehmite (B) (AlOOH) can be identified according to a method disclosed in JP 2006-62905A, comprising the steps of consolidating a sample on a non-reflecting glass plate; then measuring a diffraction pattern of the sample powder with an X-ray diffractometer, RINT 2000, manufactured by Rigaku Corporation; and comparing the diffraction pattern with JCPDS (Joint Committee on Diffraction Standards) 21-1307.

Boehmite (B) may contain a small amount of powders having a crystal structure of gibbsite or bayerite, both being represented by the chemical formula of Al(OH)₃ or Al₂O₃·3H₂O. In this case, a ratio of peak height of a main peak, which indicates a gibbsite or bayerite structure in a powder XRD spectrum, to peak height of a main peak, which indicates a boehmite structure therein, is usually 5% or less. Also, boehmite (B) may contain amorphous aluminum hydroxide.

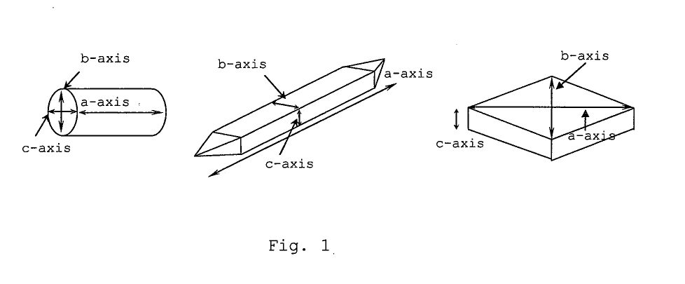

The ratio (a-axis length to b-axis length) of boehmite (B) is 5 or more, preferably 5 to 50, more preferably 5 to 30, and further preferably 10 to 30, from a viewpoint of mechanical strength such as rigidity of molded articles, and moldability of the boehmite-filled polypropylene resin composition. The ratio (a-axis length to b-axis length) of boehmite (B) in the present invention is a ratio of a-axis directional length to b-axis directional length, wherein the a-axis is determined according to a method comprising the steps of taking a photograph of boehmite (B) using an electron or optical microscope, then selecting a particle of boehmite (B) non-overlapping with other particles in the photograph, and assigning the longest axis in the selected particle to the a-axis, and an axis at right angle to the a-axis is assigned to the b-axis. FIG. 1 exemplifies shapes of particles of boehmite (B), and shows an a-axis, a b-axis and a c-axis of those particles. The c-axis is at right angle to each of the a-axis and the b-axis. The a-axis, the b-axis and the c-axis have a relation in their axis length: a-axis length>b-axis length>c-axis length. Each of the a-axis length and the b-axis length is calculated as a number average value of measured values of ten samples randomly selected from a scanning electron micrograph. Also, the b-axis length is divided into suitable size-carrying classes, thereby making histogram representation. When the histogram has two peaks, there are taken the steps of dividing into two groups at the center between those two peaks, then calculating number average values of axis length in respective groups, and further dividing into a larger number average value (b-axis length) and a smaller number average value (c-axis length).

From a viewpoint of mechanical strength such as rigidity of molded articles, and moldability of the boehmite-filled polypropylene resin composition, boehmite (B) in the present invention has an a-axis length of preferably 0.3 μm to 10 μm, more preferably 0.5 μm to 5 μm, and further preferably 1 to 4 μm, and has a c-axis length of preferably 0.03 μm to 0.3 μm, and more preferably 0.05 μm to 0.3 μm.

A shooting procedure of photographs with use of an electron microscope comprises the following steps of dispersing boehmite particles in a solvent, thereby obtaining a dispersion liquid having a solid content concentration of 1% or less, the above solvent being suitably selected from solvents easily dispersing boehmite particles, such as water and alcohols; reducing aggregation among the particles by a method such as agitation and ultrasonic irradiation, thereby obtaining a dispersion liquid; applying the dispersion liquid on a specimen support, and then drying, thereby obtaining a measurement sample; shooting electron microscope images with use of the measurement sample; suitably selecting a particle of boehmite non-overlapping with other particles; and measuring a-axis length, b-axis length and c-axis length of boehmite according to the above-mentioned method.

Boehmite (B) has a BET specific surface area of 20 to 80 m²/g, preferably 30 to 80 m²/g, and particularly preferably 50 to 80 m²/g, from a viewpoint of mechanical strength such as rigidity of molded articles.

Boehmite (B) can be obtained according to, for example, a method comprising the steps of adding a metal acetate together with aluminum hydroxide to water, and hydrothermally treating, as disclosed in JP 2000-239014A; and a method comprising the step of hydrothermally treating boehmite-typed aluminum hydroxide and gibbsite-typed aluminum hydroxide in the presence of magnesium, as disclosed in JP 2006-160541A. Also, boehmite (B) can be obtained according to a method comprising the steps of adding a metal acetate together with aluminum hydroxide to water, thereby obtaining an aqueous solution, then acidizing the aqueous solution by a carboxylic acid or the like, and hydrothermally treating.

From a viewpoint of rigidity and a heat resistance of molded articles, the polypropylene resin composition of the present invention contains preferably aromatic carboxylic acids, and further preferably compounds having a condensed aromatic ring and a carboxyl group. The condensed aromatic ring may contain a hetero atom. A compound having a condensed aromatic ring and a carboxyl group is referred to as R-COOH. Examples of compounds having a structure R-H, whose R corresponds to the above-mentioned R, are indene, naphthalene, fluorene, phenanthrene, anthracene, pyrene, chrysene, naphthacene, benzofuran, isobenzofuran, benzo[b]thiophene, indole, isoindole, benzoxazole, quinoline, isoquinoline, cinnoline, phthalazine, quinazoline, quinoxaline, dibenzofuran, carbazole, acridine, phenanthridine, 1,10-phenanthridine, phenazine, phenoxazine, thianthren, and indolizine. In the present invention, aromatic carboxylic acids may be used in combination of two or more kinds of them.

Examples of the aromatic carboxylic acids are benzoic acid, 1-naphthoic acid, 2-naphthoic acid, 4-methyl-1-naphthoic acid, 4-hydroxy-1-naphthoic acid, 6-hydroxy-2-naphthoic acid, naphthalic acid, 1-anthracene carboxylic acid, 2-anthracene carboxylic acid, and 9-anthracene carboxylic acid. Among them, preferred is benzoic acid, 1-naphthoic acid, 2-naphthoic acid, 1-anthracene carboxylic acid, 2-anthracene carboxylic acid, or 9-anthracene carboxylic acid; more preferred is 1-naphthoic acid, 2-naphthoic acid, 1-anthracene carboxylic acid, 2-anthracene carboxylic acid, or 9-anthracene carboxylic acid; and further preferred is 1-naphthoic acid or 2-naphthoic acid.

When using an aromatic carboxylic acid, the aromatic carboxylic acid is blended in an amount of preferably 0.01 to 10 parts by weight, more preferably 0.05 to 5 parts by weight, and further preferably 0.1 to 3 parts by weight, the total of the polypropylene resin (A) and boehmite (B) being 100 parts by weight, from a viewpoint of mechanical strength such as rigidity of molded articles, and moldability of the composition.

In the present invention, the polypropylene resin (A) is contained in an amount of 50 to 99% by weight, preferably 60 to 95% by weight, and further preferably 70 to 95% by weight, and boehmite (B) is contained in an amount of 1 to 50% by weight, preferably 5 to 40% by weight, and further preferably 5 to 30% by weight, the total content of the components (A) and (B) being 100% by weight, from a viewpoint of improvement of mechanical strength such as rigidity, ease of production and moldability.

The resin composition of the present invention is not particularly limited in its production method. For example, the resin composition of the present invention can be produced according to a process comprising the steps of mixing all the components, thereby obtaining a homogeneous mixture, and then melt-kneading the mixture.

The above homogeneous mixture is obtained, for example, according to a method of mixing by a Henschel mixer, a ribbon blender, a blender or the like. The above homogeneous mixture is melt-kneaded, for example, by a Banbury mixer, PLASTMIL, BRABENDER PLASTOGRAPH, a single or twin screw extruder, or the like.

The polypropylene resin composition of the present invention may contain various kinds of additives, depending on the intended use, for example, additives for modification such as nucleating agents, antioxidants, weather resistance agents, light stabilizers, ultraviolet absorbers, antistatic agents, slipping agents, antiblocking agents, antifog additives, pigments, heat stabilizers, neutralizing agents, dispersing agents, plasticizers, and flame retardants; and coloring agents such as pigments and dyes. Also, inorganic particles known in the art may be contained as fillers, for example, particulate fillers such as carbon black, titanium oxide, talc, calcium carbonate, mica and clay; short-fiber fillers such as wollastonite; and whiskers such as potassiumtitanate. Further, modifiers known in the art may be contained, for example, rubbers and modified resins such as polypropylenes modified by maleic anhydride. Those additives, fillers or modifiers may be added to the polypropylene resin composition of the present invention during the production of the resin composition, or may be added thereto during the production of molded articles from the resin composition.

The polypropylene resin composition of the present invention can be molded according to a suitable molding method, thereby obtaining molded articles. Examples of the molding method are an injection molding method, an injection compression molding method, a gas assist molding method, and an extrusion molding method.

Molded articles obtained from the polypropylene resin composition of the present invention are used, for example, as automotive plastic parts, and examples thereof are parts in an engine room, which require rigidity, heat resistance and dimension stability. Examples of the parts in an engine room are a bumper beam, a cooling fan, a fan shroud, a lamp housing, a car heater case, a fuse box, an air cleaner case, a front-end module, a cylinder head cover, an engine mount, air intake pipe, a surge tank, air intake manifold, a throttle body, a radiator tank, a radiator support, a water inlet, a water outlet, a water pump impeller, an oil filter housing, oil filler cap, a timing belt cover, and an engine ornament cover.

### EXAMPLE

The present invention is explained with the following Examples, which are merely exemplified embodiments, and do not limit the present invention.

Samples for evaluation used in Example or Comparative Example were produced according to the following methods.
(1) Production method of samples for evaluation

Samples for evaluation were molded under the following conditions, using an injection molding machine, J28SC, manufactured by The Japan Steel Works, Ltd.:
mold clamping force: 270 kN,
cylinder temperature: 200° C.,
mold temperature: 50° C., and
back pressure: 0.5 MPa.

Tables 1 to 3 show compositions of samples used in Examples and Comparative Examples.

Next, the followings are evaluation methods used in Examples and Comparative Examples.
(1) Flexural modulus (unit: MPa)

It was measured according to A.S.T.M. D790 under the following conditions:
measurement temperature: 23° C.;
sample shape: 12.7×80 mm (thickness of 4.0 mm)
span: 64 mm; and
tensile speed: 2 mm/minute.
(2) IZOD impact strength (unit: kJ/m²)

It was measured according to A.S.T.M. D256 under the following conditions:
measurement temperature: 23° C.; and
sample shape: 12.7×64 mm (thickness of 4.0 mm); wherein molded samples were notched.
(3) Heat distortion temperature (unit: ° C.)

It was measured according to A.S.T.M. D648 under the following conditions:
load stress: 0.45 MPs
sample thickness: 4 mm.
(4) Linear expansion coefficient (unit: 1/° C.) It was measured using a thermal mechanical analysis equipment, TMA-40, manufactured by Shimadzu Corporation, according a method comprising the steps of:
   preparing a tensile test specimen by injection molding;
   annealing the tensile test specimen at 120° C. for 30 minutes
   cutting out a test specimen having a size of 12.7×12.7×3 (mm) from the central region of the tensile test specimen;
   measuring the correct size of the test specimen at 23° C.;
   setting the test specimen on the thermal mechanical analysis equipment to measure a dimensional change in an MD or TD direction of the above injection molding;
   heating the test specimen from −30 to 80° C. at a temperature-increasing rate of 5° C./minute;
   measuring a dimensional change in an MD direction during heating from −30 to 80° C.; and
   calculating a dimensional change per unit length and unit temperature, on the basis of the dimension at 23° C., thereby obtaining a linear expansion coefficient.

### Preparation of Boehmite

### Reference Example 1

There were mixed 100 parts by weight of aluminum hydroxide having a BET specific surface area of 25 m²/g, a central particle diameter of 0.5 μm and a gibbsite structure, 219 parts by weight of magnesium acetate tetrahydrate [CH₃COOMg·4H₂O], and 2,100 parts by weight of pure water, thereby obtaining a slurry. Acetic acid [CH₃COOH] was added to the slurry, thereby adjusting its hydrogen-ion concentration to pH of 5.0. The slurry was put in an autoclave, and was heated up to 200° C. from room temperature [about 23° C.] at a rate of temperature increase of 100° C./hour, and was maintained at 200° C. for 4 hours, thereby reacting hydrothermally. The reaction mixture was cooled, and was filtered, thereby obtaining the resultant solid. The solid was washed with water until its filtrate showed an electrical conductivity of 100 μS/cm or less. Pure water was added to the washed solid, thereby obtaining its slurry having a solid concentration of 5% by weight. The slurry was filtered with a SUS-made sieve having an opening of 45 μm to remove coarse particles. The obtained slurry was spray-dried with a spray dryer, type MOBILE MINOR, manufactured by Niro Japan Co., Ltd., at an outlet temperature of 120° C., and then was pulverized with ROTOR SPEED MILL, P-14, manufactured by Fritsch Japan Co., Ltd., thereby obtaining powder (B-1) . This powder was confirmed to be boehmite (AlOOH) based on its powder XRD pattern. This boehmite (B-1) had a BET specific surface area of 66 m²/g, an a-axis length of 2,520 nm, a b-axis length of 102 nm, a c-axis length of 102 nm, and a ratio of the a-axis length to the b-axis length (a-axis length/b-axis length) of 25. The BET specific surface area was measured according to a nitrogen adsorption method. Each of the a-axis length, the b-axis length and the c-axis length was calculated as a number average value of measured values of ten samples randomly selected from a scanning electron micrograph. The ratio of the a-axis length to the b-axis length (a-axis length/b-axis length) was calculated as a number average value of respective values obtained by dividing each a-axis length by each b-axis length of the above ten samples.

### Reference Example 2

There were mixed 100 parts by weight of commercially-available gibbsite type aluminum hydroxide, C-301, having a central particle diameter of 1.4 μm, manufactured by Sumitomo Chemical Co., Ltd., 46 parts by weight of magnesium acetate tetrahydrate, and 3,200 parts by weight of pure water, thereby obtaining a slurry. The slurry had a hydrogen-ion concentration of pH of 7.7. Then, the slurry was put in an autoclave, and was heated up to 200° C. from room temperature [20° C.] at a rate of temperature increase of 100° C./hour, and was maintained at 200° C. for 4 hours, thereby reacting hydrothermally. The reaction mixture was cooled, and was filtered, thereby obtaining the resultant solid. The solid was washed with water until its filtrate showed an electrical conductivity of 100 μS/cm or less. Pure water was added to the washed solid, thereby obtaining its slurry having a solid concentration of 5% by weight. The slurry was filtered with a SUS-made sieve having an opening of 45 μm to remove coarse particles. The obtained slurry was spray-dried with a spray dryer, type MOBILE MINOR, manufactured by Niro Japan Co., Ltd., at an outlet temperature of 120° C., and then was pulverized with ROTOR SPEEDMILL, P-14, manufactured by Fritsch Japan Co., Ltd., thereby obtaining powder (B-2) . This powder was confirmed to have a boehmite structure based on its powder XRD pattern. Boehmite (B-2) had a BET specific surface area of 13 m²/g, an a-axis length of 4,820 nm, a b-axis length of 440 nm, a c-axis length of 440 nm, and a ratio of the a-axis length to the b-axis length (a-axis length/b-axis length) of 11. The BET specific surface area was measured according to a nitrogen adsorption method. Each of the a-axis length, the b-axis length and the c-axis length was calculated as a number average value of measured values of ten samples randomly selected from a scanning electron micrograph. The ratio of the a-axis length to the b-axis length (a-axis length/b-axis length) was calculated as a number average value of respective values obtained by dividing each a-axis length by each b-axis length of the above ten samples.

### Production of Polypropylene Resin Composition and Evaluation Thereof

### Example 1

A propylene homopolymer (A-1) and boehmite (B-1) obtained in Reference Example 1 were mixed with each other in a compounding ratio described in Table 1. There were added to the resultant mixture, 0.05 part by weight of calcium stearate manufactured by NOF Corporation, 0.1 part by weight of IRGANOX 1010 manufactured by Ciba Specialty Chemicals K.K., and 0.1 part by weight of IRGAFOS 168 manufactured by Ciba Specialty Chemicals K.K., the total of the components (A-1) and (B-1) being 100 parts by weight. The mixture was mixed homogeneously. The obtained mixture was melt-kneaded at a predetermined temperature of 180° C. and at a screw rotation speed of 500 rpm, using a double screw-kneading extruder, KZW15-45MG, manufactured by Technovel Corporation, the two screws rotating in the same direction and having a size of 15 mm×45 L/D, thereby obtaining pellets. The pellets were injection molded with a molding machine, J28SC, manufacture by The Japan Steel Works, Ltd., thereby obtaining a molded article. Table 1 shows flexural modulus and heat distortion temperature of the molded article.

The used propylene homopolymer (A-1) was produced according to a method disclosed in Example of JP 2006-083251A. The propylene homopolymer (A-1) had an MFR of 25 g/10 minutes.

### Example 2

Example 1 was repeated except that 1.0 part of 2-naphthoic acid (C-1) manufactured by Tokyo Chemical Industry Co., Ltd. was added at the time of the homogeneous mixing of all the components in Example 1, as described in Table 1.

### Comparative Example 1

Example 1 was repeated except that boehmite (B-1) was changed to talc (D-1), MWHST, manufactured by HAYASHI KASEI Co., Ltd., which was mixed with the propylene homopolymer (A-1) in a compounding ratio described in Table 2.

### Comparative Example 2

Example 1 was repeated except that boehmite (B-1) was changed to fibrous magnesium sulfate (D-2), MOS-HIGE A, manufactured by Ube Material Industries, which was mixed with the propylene homopolymer (A-1) in a compounding ratio described in Table 2.

The above fibrous magnesium sulfate (D-2) had an average fiber diameter of 0.5 μm, an average fiber length of 10 μm, and an aspect ratio of 20.

### Comparative Example 3

Comparative Example 1 was repeated except that the compounding ratio of the propylene homopolymer (A-1) to talc (D-1) was changed as described in Table 2.

### Comparative Example 4

Example 1 was repeated except that boehmite (B-1) was not used.

### Comparative Example 5

Example 1 was repeated except that boehmite (B-1) was changed to boehmite (B-2), which was mixed with the propylene homopolymer (A-1) in a compounding ratio described in Table 2.

TABLE 1

Example

| Compounding ratio (part by weight) | 1 | 2 |
|---|---|---|
| (A) Polypropylene resin | | |
| Kind | A-1 | A-1 |
| Compounding ratio (part by weight) | 80 | 80 |
| (B) Boehmite | | |
| Kind | B-1 | B-1 |
| Compounding ratio (part by weight) | 20 | 20 |
| (C) Aromatic carboxylic acid | | |
| Kind | — | C-1 |
| Compounding ratio (part by weight) | — | 1 |
| (D) Other | | |
| Kind | — | — |
| Compounding ratio (part by weight) | — | — |
| Property | | |
| Flexural modulus (MPa) | 4,470 | 5,290 |
| IZOD impact strength (kJ/m²) | 2 | 2 |
| Heat distortion temperature (° C.) | 143 | 145 |
| Linear expansion coefficient (1/C. °) | 2.8 | 2.5 |

TABLE 2

| Compounding ratio | Comparative Example | | | | |
|---|---|---|---|---|---|
| (part by weight) | 1 | 2 | 3 | 4 | 5 |
| (A) Polypropylene resin | | | | | |
| Kind | A-1 | A-1 | A-1 | A-1 | A-1 |
| Compounding ratio | 80 | 80 | 90 | 100 | 80 |
| (part by weight) | | | | | |
| (B) Boehmite | | | | | |
| Kind | — | — | — | — | B-2 |
| Compounding ratio | — | — | — | — | 20 |
| (part by weight) | | | | | |
| (C) Aromatic carboxylic | | | | | |
| acid | | | | | |
| Kind | — | — | — | — | — |
| Compounding ratio | — | — | — | — | — |
| (part by weight) | | | | | |
| (D) Other | | | | | |
| Kind | D-1 | D-2 | D-1 | — | — |
| Compounding ratio | 20 | 20 | 10 | — | — |
| (part by weight) | | | | | |
| Property | | | | | |
| Flexural modulus (MPa) | 3,020 | 4,310 | 2,370 | 1,440 | 3,856 |
| IZOD impact strength | 2 | 2 | 3 | 2 | 2 |
| (kJ/m²) | | | | | |
| Heat distortion | 135 | 142 | 123 | 96 | 134 |
| temperature (° C.) | | | | | |
| Linear expansion | 6.8 | 3.2 | — | — | — |
| coefficient (1/° C.) | | | | | |

A-1: propylene homopolymer
B-1: boehmite (BET specific surface area=66 m²/g, a-axis length=2,520 nm, b-axis length=102 nm, c-axis length=102 nm, a-axis length/b-axis length=27)
B-2: boehmite (BET specific surface area=13 m²/g, a-axis length=4,820 nm, b-axis length=440 nm, c-axis length=440 nm, a-axis length/b-axis length=11)
C-1: 2-naphthoic acid (manufactured by Tokyo Chemical Industry Co., Ltd.)
D-1: talc (manufactured by HAYASHI KASEI Co., Ltd., trade name of MWHST)
D-2: fibrous magnesium sulfate (manufactured by Ube Material Industries, trade name of MOS-HIGE A)

The molded articles in Examples 1 and 2 are excellent in their rigidity, heat resistance and dimensional stability. On the other hand, the molded articles in Comparative Examples 1 to 5 containing no boehmite (B) are insufficient in their rigidity and heat resistance. Also, the molded articles in Comparative Examples 1 and 2 are insufficient in their dimensional stability.

### INDUSTRIAL APPLICABILITY

Molded articles excellent in their rigidity and dimensional stability can be obtained from the polypropylene resin composition of the present invention.

1. A polypropylene resin composition comprising:
50 to 99% by weight of a polypropylene resin (A), which contains a propylene homopolymer and/or a propylene-ethylene random copolymer containing 1.0% by weight or less of ethylene units; and
1 to 50% by weight of boehmite (B) having a BET specific surface area of 20 to 80 m²/g, c-axis length of 30 to 300 nm, and a ratio of a-axis length to b-axis length (a-axis length/b-axis length) of 5 or more;
provided that the total of the polypropylene resin (A) and boehmite (B) is 100% by weight.

2. The polypropylene resin composition according to claim 1, wherein boehmite (B) has a-axis length of 0.3 to 10 μm.

3. A molded article comprising the polypropylene resin composition of claim 1.

4. A molded article comprising the polypropylene resin composition of claim 2.
